(19) United States
(12) Patent Application Publication
(10) Pub. No.: US 2026/0341666 A1
(43) Pub. Date: Oct. 29, 2026

(54) ELECTRODE MANUFACTURING DEVICE

(71) Applicant: SK ON CO., LTD., Seoul (KR)

(72) Inventors: Han Yeob KIM, Daejeon (KR); Cheol Wan KIM, Daejeon (KR)

(21) Appl. No.: 19/660,266

(22) Filed: Apr. 28, 2026

(30) Foreign Application Priority Data
Apr. 28, 2025 (KR) 10-2025-0055391

(51) Int. Cl. H01M 4/04; B21D 22/02

(52) U.S. Cl. CPC H01M 4/04; B21D 22/02

(57) ABSTRACT

An electrode manufacturing device is disclosed. The electrode manufacturing device according to an embodiment of the present disclosure includes: an oil stamping unit including a stamper formed of a porous material; and an oil supply unit configured to supply oil to the oil stamping unit, wherein the oil stamping unit includes: a bracket to which the stamper is coupled; and a mover coupled to the bracket and configured to move the bracket.

### CROSS-REFERENCE TO RELATED APPLICATION

This patent application claims the priority and benefits of Korean patent application No. 10-2025-0055391, filed on Apr. 28, 2025, the disclosure of which is incorporated herein by reference in its entirety.

### BACKGROUND OF THE INVENTION

### 1. Field of the Invention

The present disclosure relates to an electrode manufacturing device.

### 2. DESCRIPTION OF THE RELATED ART

A process for manufacturing an electrode used in a secondary battery may include a process for cutting the electrode. The electrode manufacturing process may include a process for applying oil to the electrode before cutting the electrode. If oil is applied unnecessarily to the electrode, the quality of the electrode may deteriorate.

### SUMMARY OF THE INVENTION

An object of the present disclosure is to provide an electrode manufacturing device that applies oil to a selected region among a plurality of regions of an electrode.

An electrode manufacturing device according to the present disclosure may include: an oil stamping unit including a stamper formed of a porous material; and an oil supply unit configured to supply oil to the oil stamping unit, wherein the oil stamping unit may include: a bracket to which the stamper is coupled; and a mover coupled to the bracket and configured to move the bracket.

The bracket may include a bracket top that forms an opening, wherein the stamper may be located below the bracket top.

The stamper may be exposed through the opening of the bracket top, and the oil supply unit may include an oil spraying unit configured to spray oil toward the opening.

The bracket may further include a bracket finger connected to the bracket top, and the stamper may be coupled and fixed to the bracket finger.

The bracket may include: a bracket wall extending downward from an upper end to a lower end and forming a hollow portion; and a bracket bottom connected to a lower end portion of the bracket wall and forming an opening.

The stamper may include: a stamper body accommodated in the hollow portion; and a stamper hand protruding downward from the stamper body and passing through the opening formed in the bracket bottom.

An inner surface of the bracket wall may face the stamper body and have a frustum shape.

A cross-sectional area of the inner surface of the bracket wall may increase toward the bracket bottom.

The stamper may be accommodated in a hollow portion formed in the bracket and open upward, and the oil supply unit may include an oil supply tube connected to the bracket and configured to provide oil.

The stamper may have a shape protruding upward from an upper end of the bracket.

The oil supply unit may include: a housing to which the bracket is detachably coupled and which forms a space open upward; and an oil supply tube configured to supply oil to the housing.

The housing may include: a housing case forming a bottom surface and an outer surface of the housing; and a housing neck having a well-wall shape extending upward from the bottom surface of the housing.

The bracket may include: a bracket bottom forming a bottom of the bracket; and a bracket cap protruding upward from the bracket bottom and coupled to the mover.

One surface of the bracket cap may be convex and may face the stamper, and the other surface of the bracket cap may be concave and may be coupled to the mover.

When the bracket is in a lowered state, the bracket cap may accommodate the housing neck, and when the bracket is in a raised state, the bracket may be located above the housing.

An electrode manufacturing device according to the present disclosure, which is configured to manufacture an electrode sheet having a first electrode surface and a second electrode surface and being transported forward, may include: an oil stamping unit including a stamper formed of a porous material and configured to move toward or away from the electrode sheet; an oil supply unit configured to provide oil to the oil stamping unit; and an electrode cutter located in front of the oil stamping unit and configured to cut the electrode sheet.

The oil stamping unit may include: a bracket to which the stamper is coupled; and a mover coupled to the bracket and configured to move the bracket toward or away from the electrode sheet.

The oil stamping unit may include: a first oil stamping unit in which the stamper faces the first electrode surface; and a second oil stamping unit in which the stamper faces the second electrode surface.

The bracket may include a bracket top that forms an opening, wherein the stamper may be located below the bracket top and may face the first electrode surface, and the oil supply unit may include an oil spraying unit configured to spray oil toward the opening.

The electrode manufacturing device may further include a sensor unit configured to measure oil applied to the electrode sheet; and a control unit configured to control the oil supply unit based on a signal received from the sensor unit.

According to an embodiment of the present disclosure, there may be provided an electrode manufacturing device for applying oil to a selected region among a plurality of regions of an electrode.

The electrode manufacturing device of the present disclosure may be used in eco-friendly electric vehicles and hybrid vehicles to suppress air pollution and greenhouse gas emissions, thereby contributing to mitigating climate change.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a perspective view illustrating an electrode sheet being cut while being transported;

FIG. 2 is a cross-sectional view illustrating the electrode sheet shown in FIG. 1 taken along line A1-A2;

FIG. 3 is a view illustrating a press cutter and a stamper disposed on the electrode sheet shown in FIG. 1;

FIG. 4 is a view illustrating a laser cutter and a stamper disposed on the electrode sheet shown in FIG. 1;

FIG. 5 is a perspective view illustrating an oil stamping unit with a stamper coupled below a bracket top;

FIG. 6 is a plan view of the oil stamping unit shown in FIG. 5;

FIG. 7 is a cross-sectional view of the oil stamping unit shown in FIG. 6 taken along line B1-B2;

FIG. 8 is a perspective view illustrating the stamper attached to a bracket including a bracket top and a bracket wall;

FIG. 9 is a plan view of the oil stamping unit shown in FIG. 8;

FIG. 10 is a cross-sectional view of the oil stamping unit shown in FIG. 9 taken along line C1-C2;

FIG. 11 is a perspective view illustrating a second oil stamping unit including a bracket and a stamper accommodated in the bracket;

FIG. 12 is a perspective view illustrating an oil supply unit including a housing;

FIG. 13 is a cross-sectional view illustrating the oil supply unit shown in FIG. 12 taken along line D1-D2;

FIG. 14 is a perspective view illustrating a second oil stamping unit coupled to the oil supply unit shown in FIG. 12;

FIG. 15 is a cross-sectional view illustrating the second oil stamping unit shown in FIG. 14; and

FIG. 16 is a block diagram of an electrode manufacturing device 10 according to an embodiment of the present disclosure.

### DETAILED DESCRIPTION OF THE INVENTION

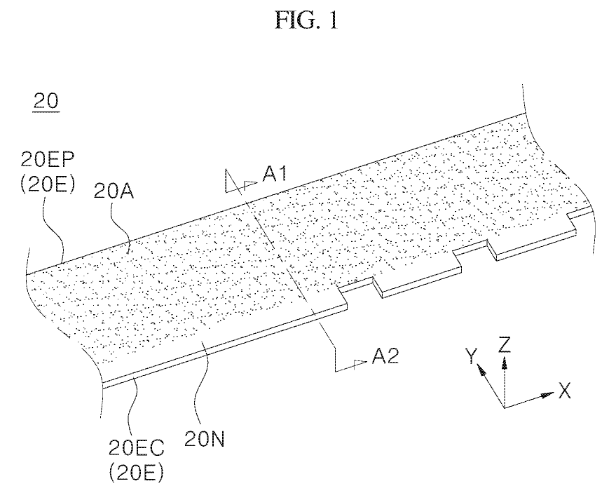

Hereafter, the present disclosure will be described in detail with reference to FIGS. 1-16. However, the embodiments are merely illustrative, and the present disclosure is not limited to the specific embodiments described as examples.

An XYZ coordinate system may be used in this specification. The XYZ coordinate system may be a Cartesian coordinate system.

For example, the Z-axis may be parallel to the vertical direction. For instance, a positive Z-axis direction may represent the upward direction, and a negative Z-axis direction may represent the downward direction.

For example, the X-axis may be parallel to the front-rear direction. For instance, a positive X-axis direction may represent the forward direction, and a negative X-axis direction may represent the rearward direction.

For example, the Y-axis may be parallel to the left-right direction. For instance, a positive Y-axis may represent the leftward direction, and a negative Y-axis may represent the rightward direction.

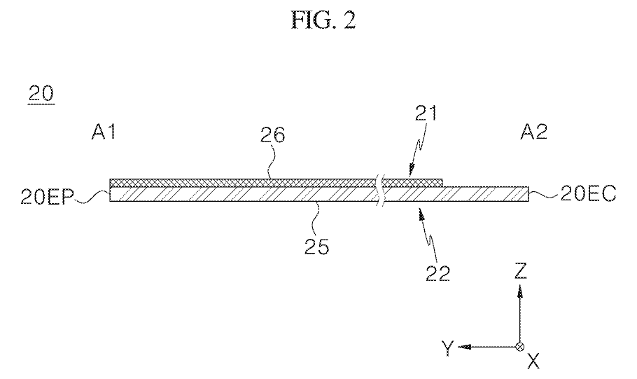

FIG. 1 is a perspective view illustrating an electrode sheet being cut while being transported. FIG. 2 is a cross-sectional view illustrating the electrode sheet shown in FIG. 1 taken along line A1-A2.

Referring to FIGS. 1 and 2, an electrode sheet 20 may be used in a secondary battery. The electrode sheet 20 may be transported while unwinding from a wound state.

For example, a transport roll (not shown) may transport the electrode sheet 20 in one direction. For example, a direction in which the electrode sheet 20 is transported while unwinding may correspond to a longitudinal direction of the electrode sheet 20. The electrode sheet 20 may have a sheet shape.

For example, the electrode sheet 20 may have two surfaces. For example, a first electrode surface 21 may be one surface of the electrode sheet 20. For example, a second electrode surface 22 may be the other surface of the electrode sheet 20.

The electrode sheet 20 may have two sides. For example, the electrode sheet 20 may extend from a cutting edge 20EC to a counter edge 20EP. An electrode sheet edge 20E may include or refer to at least one of the cutting edge 20EC and the counter edge 20EP.

The cutting edge 20EC and the counter edge 20EP may be located opposite each other. The electrode sheet edge 20E may extend in the longitudinal direction of the electrode sheet 20. The cutting edge 20EC and the counter edge 20EP may be parallel to each other.

The electrode sheet 20 may have a layered structure. For example, the electrode sheet 20 may include a current collector layer 25 and an active material layer 26.

The current collector layer 25 and the active material layer 26 may be stacked in a thickness direction of the electrode sheet 20. For example, the current collector layer 25 and the active material layer 26 may be stacked in the vertical direction.

For example, the current collector layer 25 may be formed of a metal material. For example, the current collector layer 25 may be formed of a material including at least one of aluminum and copper.

For example, the active material layer 26 may be applied to the current collector layer 25. For example, the active material layer 26 may include at least one of an active material, a binder, and a conductive material.

The electrode sheet 20 may be divided according to regions. For example, the electrode sheet 20 may include a coated portion 20A and an uncoated portion 20N. The coated portion 20A may be a region of the electrode sheet 20 where the active material layer 26 and the current collector layer 25 are stacked. The uncoated portion 20N may be a region of the electrode sheet 20 where the current collector layer 25 is exposed on both surfaces.

The coated portion 20A may form the counter edge 20E. For example, the coated portion 20A may extend from the counter edge 20E. The uncoated portion 20N may form the cutting edge 20EC. For example, the uncoated portion 20N may extend from the cutting edge 20EC.

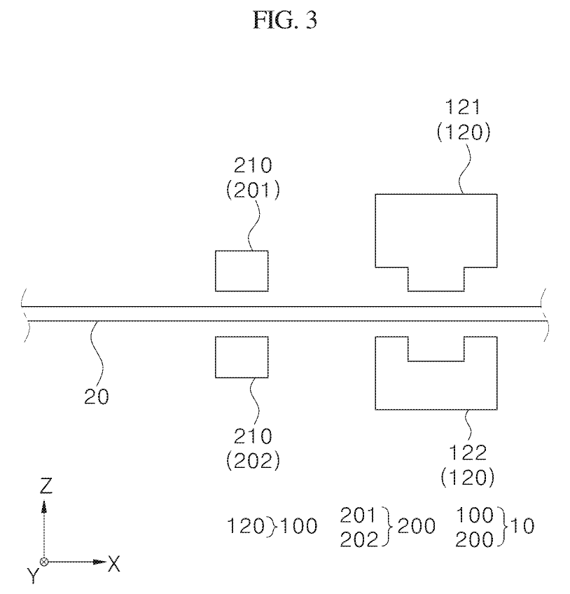

FIG. 3 is a view illustrating a press cutter and a stamper disposed on the electrode sheet shown in FIG. 1.

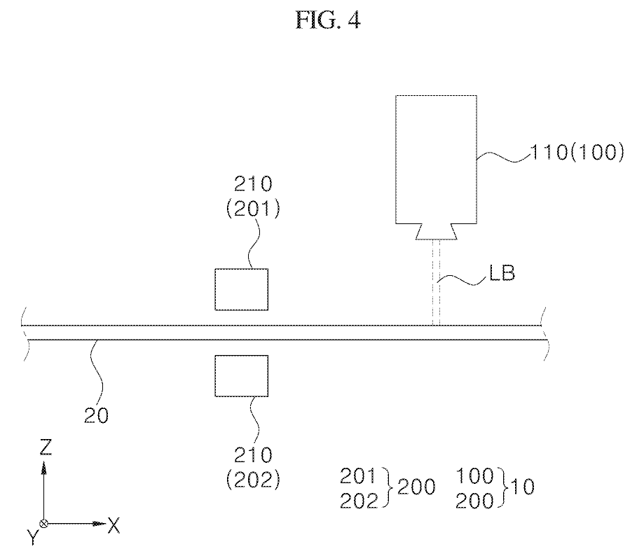

Referring to FIGS. 1-3, the electrode manufacturing device 10 may include an electrode cutter 100. For example, the electrode manufacturing device 10 may include a press cutter 120. The electrode cutter 100 may include or refer to at least one of the press cutter 120 and a laser cutter 110 (see FIG. 4).

A plurality of press cutters 120 may be provided. For example, the electrode manufacturing device 10 may include a first press cutter 121 and a second press cutter 122. The press cutter 120 may include or refer to at least one of the first press cutter 121 and the second press cutter 122.

The first press cutter 121 and the second press cutter 122 may be disposed with the electrode sheet 20 interposed therebetween. For example, the first press cutter 121 may face the first electrode surface 21. For example, the second press cutter 122 may face the second electrode surface 22.

The electrode cutter 100 may cut the electrode sheet 20. For example, the electrode cutter 100 may cut the uncoated portion 20N. For example, when the electrode cutter 100 cuts the uncoated portion 20N, the cutting edge 20EC of the electrode sheet 20 may have a protruding or recessed shape.

The first press cutter 121 and the second press cutter 122 may have corresponding shapes. For example, the first press cutter 121 may form a protruding portion toward the second press cutter 122. For example, the second press cutter 122 may form a concave portion corresponding to the first press cutter 121.

During the process of cutting the electrode sheet 20, the current collector layer 25 and the press cutter 120 may be mechanically engaged with each other. The stamper 210 may apply oil to the electrode sheet 20.

The oil applied to the electrode sheet 20 may be a lubricating oil. For example, the oil applied to the electrode sheet 20 may be a plastic working oil and may be called “punching oil.”

The electrode manufacturing device 10 may include an oil stamping unit 200. A plurality of oil stamping units 200 may be provided. For example, the electrode manufacturing device 10 may include a first oil stamping unit 201 and a second oil stamping unit 202. The oil stamping unit 200 may include or refer to at least one of the first oil stamping unit 201 and the second oil stamping unit 202.

The oil stamping unit 200 may include a stamper 210. The stamper 210 may be formed of a porous material. For example, the stamper 210 may be formed of a material including expanded rubber. For example, the stamper 210 may be formed from a material including at least one of synthetic rubber, natural latex, polyethylene, and polyurethane.

FIG. 4 is a view illustrating a laser cutter and a stamper disposed on the electrode sheet shown in FIG. 1.

Referring to FIGS. 1, 2 and 4, the electrode manufacturing device 10 may include the laser cutter 110. The laser cutter 110 may irradiate a laser beam LB onto the electrode sheet 20. When the laser beam LB is irradiated onto the electrode sheet 20, the electrode sheet 20 may be cut.

Referring to FIGS. 1-4, the electrode sheet 20 may be transported in a forward direction. The stamper 210 may apply oil to the electrode sheet 20. For example, the stamper 210 may apply oil to a region of the uncoated portion 20N to be cut.

For example, the stamper 210 of the first oil stamping unit 201 may apply oil to the first electrode surface 21 of a region of the uncoated portion 20N to be cut. For example, the stamper 210 of the second oil stamping unit 202 may apply oil to the second electrode surface 22 of a region of the uncoated portion 20N to be cut.

After the oil is applied, the electrode sheet 20 may be transported forward. The electrode cutter 100 may be located in front of the stamper 210. The electrode cutter 100 may cut the electrode sheet 20. For example, the electrode cutter 100 may cut a region of the electrode sheet 20 to which oil has been applied.

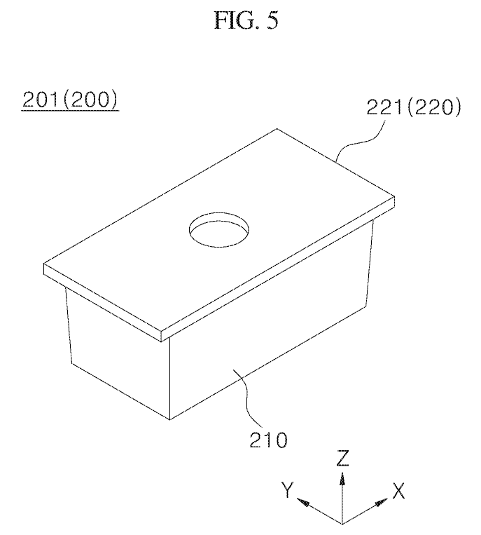

FIG. 5 is a perspective view illustrating an oil stamping unit with a stamper coupled below a bracket top.

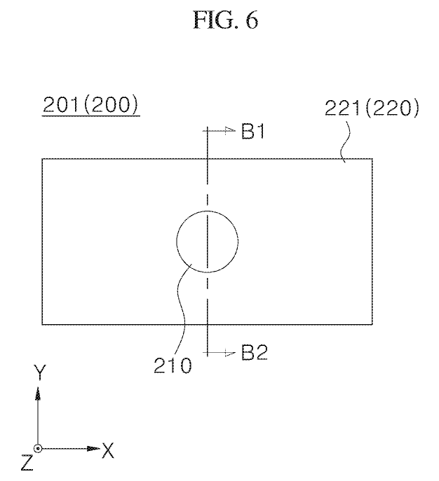

FIG. 6 is a plan view of the oil stamping unit shown in FIG. 5.

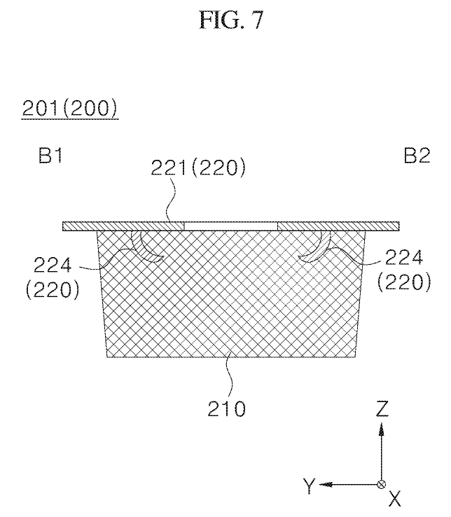

FIG. 7 is a cross-sectional view of the oil stamping unit shown in FIG. 6 taken along line B1-B2.

Referring to FIGS. 5 -7, the oil stamping unit 200 may include a bracket 220. The bracket 220 may hold the stamper 210. For example, the stamper 210 may be coupled or fixed to the bracket 220.

The bracket 220 may include a bracket top 221. The bracket top 221 may be located above the stamper 210. For example, the stamper 210 may face a lower surface of the bracket top 221, or may be in contact with or coupled to the lower surface of the bracket top 221.

The bracket top 221 may have a plate shape. For example, the bracket top 221 may have an opening formed therein. Through the opening formed in the bracket top 221, an upper surface of the stamper 210 may be exposed. For example, oil may be supplied to the stamper 210 through the opening formed in the bracket top 221.

At least a portion of the oil supplied to the upper surface of the stamper 210 may reach a lower surface of the stamper 210 through a plurality of holes formed in the stamper 210. When the stamper 210 comes into contact with the electrode sheet 20 (see FIGS. 1 to 4), the oil contained in the stamper 210 may be applied to the electrode sheet 20 (see FIGS. 1-4).

The bracket 220 may include a bracket finger 224. For example, the bracket finger 224 may be coupled or fixed to the bracket top 221. For example, the bracket finger 224 may have a shape extending from the bracket top 221. For example, the stamper 210 may be coupled or fixed to the bracket finger 224.

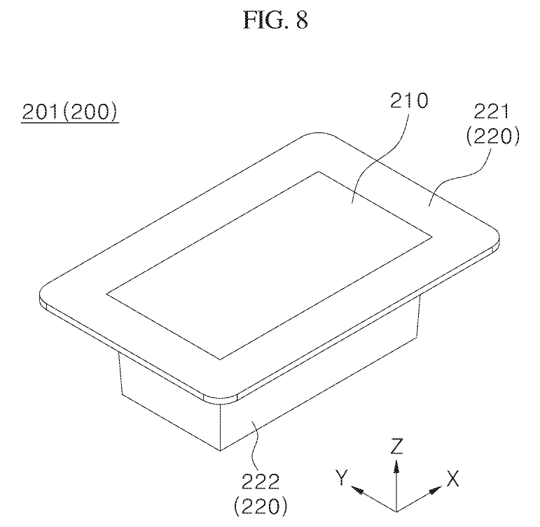

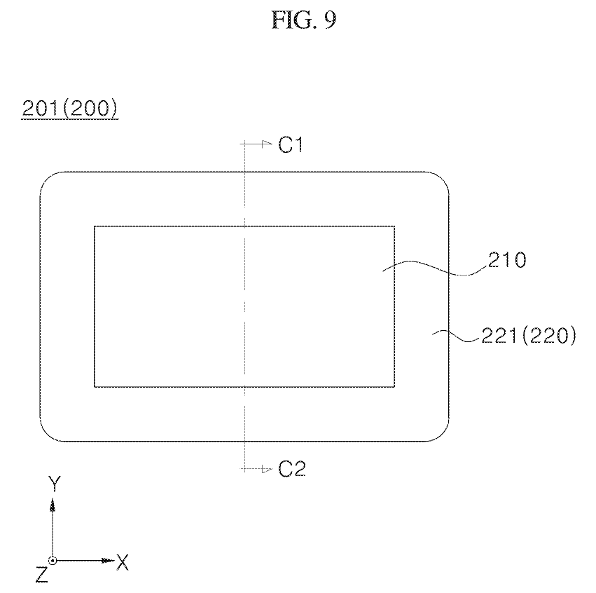

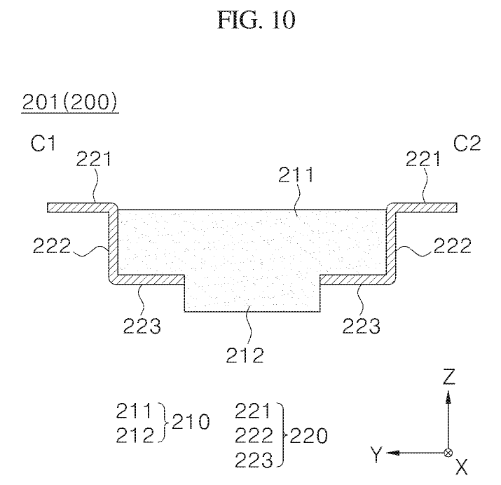

FIG. 8 is a perspective view illustrating the stamper attached to a bracket including a bracket top and a bracket wall. FIG. 9 is a plan view of the oil stamping unit shown in FIG. 8. FIG. 10 is a cross-sectional view of the oil stamping unit shown in FIG. 9 taken along line C1-C2.

Referring to FIGS. 8-10, the bracket 220 may include the bracket top 221 and a bracket wall 222. The bracket top 221 may have an opening formed therein.

Through the opening formed in the bracket top 221, the upper surface of the stamper 210 may be exposed. For example, through the opening formed in the bracket top 221, the stamper 210 may be fitted into and coupled to the bracket 220.

The bracket 220 may include the bracket wall 222. The bracket wall 222 may be connected or coupled to the bracket top 221. For example, the bracket wall 222 may extend downward from the bracket top 221.

For example, the bracket wall 222 may extend downward from an inner periphery of the bracket top 221. The inner periphery of the bracket top 221 may form the opening of the bracket top 221.

An inner surface of the bracket wall 222 may face the stamper 210. The inner surface of the bracket wall 222 may have a pillar shape. For example, the inner surface of the bracket wall 222 may have a frustum shape.

For example, the inner surface of the bracket wall 222 may have a frustum shape, and an area of an upper portion of the inner surface of the bracket wall 222 may be larger than an area of a lower portion of the inner surface of the bracket wall 222.

The cross-sectional area of the inner surface of the bracket wall 222 may decrease toward a bracket bottom 223. In this case, the stamper 210 may be easily coupled to the bracket 220.

For example, the inner surface of the bracket wall 222 may have a frustum shape, and the area of the upper portion of the inner surface of the bracket wall 222 may be smaller than the area of the lower portion of the inner surface of the bracket wall 222.

The cross-sectional area of the inner surface of the bracket wall 222 may increase toward the bracket bottom 223. In this case, the bracket wall 222 may prevent the stamper 210 from being separated from the bracket 220.

The bracket 220 may include the bracket bottom 223. The bracket bottom 223 may form the lower surface or bottom of the bracket 220. The bracket bottom 223 may be connected or coupled to the bracket wall 222.

For example, the bracket bottom 223 may be connected or coupled to a lower end of the bracket wall 222. For example, an outer periphery of the bracket bottom 223 may be connected or coupled to the lower end of the bracket wall 222.

The bracket bottom 223 may have an opening formed therein. For example, an inner periphery of the bracket bottom 223 may form an opening. For example, the bracket bottom 223 may extend from the inner periphery of the bracket bottom 223 to the outer periphery of the bracket bottom 223.

The stamper 210 may include a stamper body 211. For example, the stamper body 211 may be coupled to the bracket 220. For example, the stamper body 211 may be located in a space defined by the bracket wall 222 and the bracket bottom 223.

For example, a lateral face of the stamper body 211 may face the bracket wall 222. For example, a portion of a bottom surface of the stamper body 211 adjacent to a periphery of the bottom surface may face the bracket bottom 223.

The stamper 210 may include a stamper hand 212. The stamper hand 212 may protrude downward from or extend from the stamper body 211. For example, the stamper hand 212 may have a shape protruding downward from the bracket bottom 223.

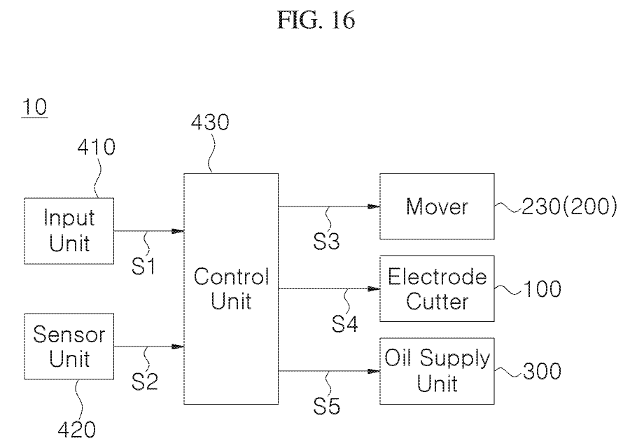

An oil supply unit 300 (see FIG. 16) may supply or spray oil onto an upper surface of the stamper body 211. At least a portion of the oil located on the upper surface of the stamper body 211 may move downward to reach a lower surface of the stamper hand 212.

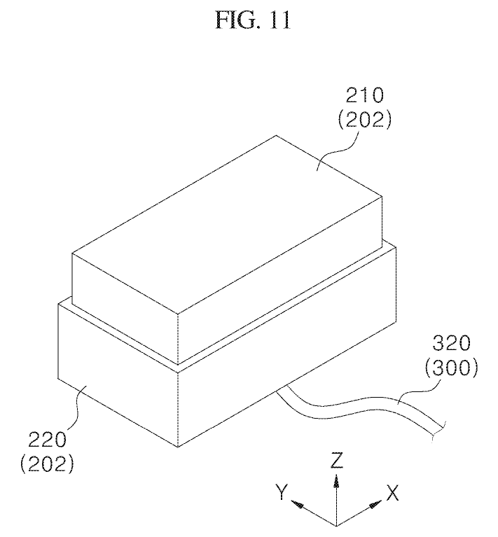

FIG. 11 is a perspective view illustrating the second oil stamping unit including the bracket and the stamper accommodated in the bracket.

Referring to FIG. 11, the second oil stamping unit 202 may include the bracket 220 and the stamper 210 accommodated in the bracket 220. The bracket 220 may form a hollow portion open upward.

For example, the inner surface of the bracket 220 may have a shape corresponding to a shape of an outer surface of the stamper 210. For example, the bracket 220 may accommodate the stamper 210.

For example, an inner surface of the bracket bottom 223 (see FIG. 10) of the bracket 220 may face or contact the lower surface of the stamper 210. For example, the inner surface of the bracket wall 222 (see FIG. 10) of the bracket 220 may face or contact a lateral face of the stamper 210.

The oil supply unit 300 may include an oil supply tube 320. The oil supply tube 320 may be connected to the bracket 220. For example, one end portion of the oil supply tube 320 may be connected to the bracket 220.

A space may be formed inside the oil supply tube 320. For example, the space formed inside the oil supply tube 320 may be in communication with the hollow portion formed in the bracket 220.

Oil may be supplied to an inside of the bracket 220 through the oil supply tube 320. At least a portion of the oil supplied to the inside of the bracket 220 may be delivered to the stamper 210. At least a portion of the oil delivered to the stamper 210 may reach the upper surface of the stamper 210.

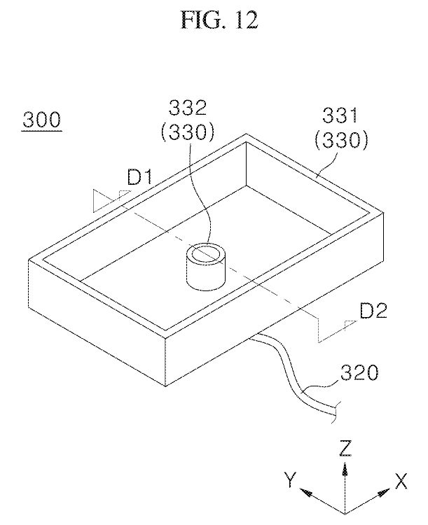

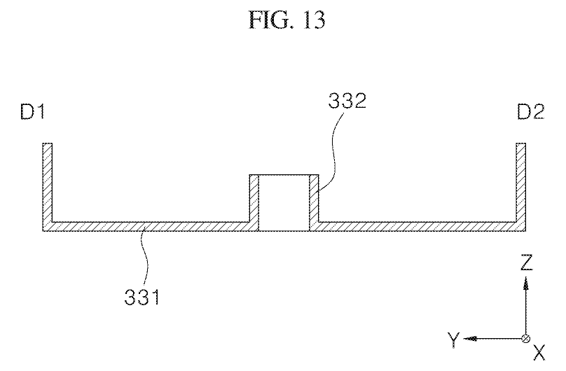

FIG. 12 is a perspective view illustrating an oil supply unit including a housing. FIG. 13 is a cross-sectional view illustrating the oil supply unit shown in FIG. 12 taken along line D1-D2.

Referring to FIGS. 12 and 13, the oil supply unit 300 may include a housing 330. The housing 330 may maintain a fixed position with respect to the electrode sheet 20 (see FIGS. 1-4).

The housing 330 may include a housing case 331. The housing case 331 may have a space open upward. For example, the housing case 331 may contain liquid, etc.

The housing case 331 may include a bottom surface and a side wall. A lower end portion of the side wall of the housing case 331 may be connected to a periphery of the housing case 331.

The housing 330 may include a housing neck 332. The housing neck 332 may be connected or coupled to the housing case 331. For example, the housing neck 332 may extend upward from the housing case 331.

For example, the housing neck 332 may have a shape extending upward from an opening formed in a bottom surface of the housing case 331. For example, the housing neck 332 may have a well-wall shape extending upward from the opening formed in the bottom surface of the housing case 331. For example, the housing neck 332 may have a hollow portion formed therein. The hollow portion formed in the housing neck 332 may be open upward and downward.

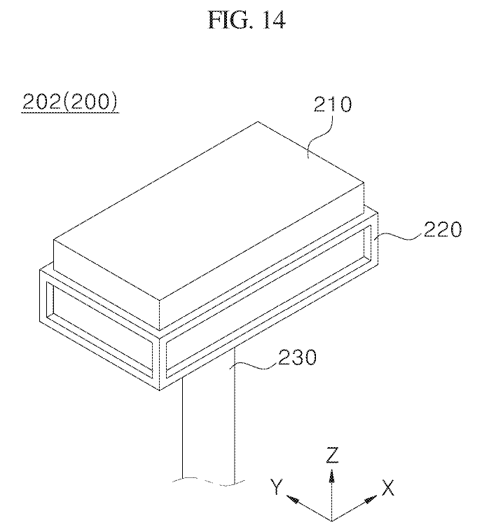

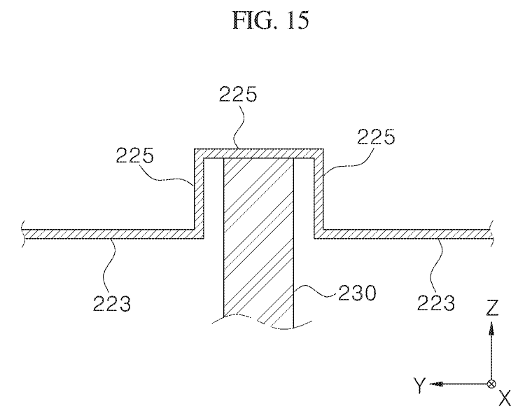

FIG. 14 is a perspective view illustrating the second oil stamping unit coupled to the oil supply unit shown in FIG. 12. FIG. 15 is a cross-sectional view illustrating the second oil stamping unit shown in FIG. 14.

Referring to FIGS. 14 and 15, the bracket 220 may include a bracket cap 225. The bracket cap 225 may have a shape extending upward or protruding from the bracket bottom 223.

The bracket cap 225 may have two surfaces. For example, a first surface of the bracket cap 225 may be connected to an upper surface of the bracket bottom 223. For example, the first surface of the bracket cap 225 may be convex.

For example, a second surface of the bracket cap 225 may be connected to a lower surface of the bracket bottom 223. For example, the second surface of the bracket cap 225 may be concave. For example, the second surface of the bracket cap 225 may be connected or coupled to a mover 230.

The bracket cap 225 may be formed as a mesh structure. For example, the bracket 220 may be formed entirely as a mesh structure. For example, the bracket cap 225 may form a grid pattern.

The oil stamping unit 200 may include the mover 230. The mover 230 may be connected or coupled to the bracket 220. The mover 230 may move the bracket 220. For example, the bracket 220 may be moved upward and downward by the mover 230.

For example, an end portion of the mover 230 may be coupled to the bracket cap 225. For example, the end portion of the mover 230 may be coupled to the second surface of the bracket cap 225. For example, an upper end portion of the mover 230 may be accommodated in the bracket cap 225.

Referring to FIGS. 12-15, a gap may be formed between the mover 230 and the bracket cap 225. When the mover 230 is in a lowered state, the housing neck 332 may be located in the gap formed between the mover 230 and the bracket cap 225.

When the mover 230 is in a lowered state, a lower end portion of the stamper 210 may be accommodated in the housing case 331. For example, when the mover 230 is in the lowered state, oil may be introduced into the lower end portion of the stamper 210. At least a portion of the oil introduced into the lower end portion of the stamper 210 may reach the upper surface of the stamper 210.

When the mover 230 is raised, the bracket 220 may be raised. When the bracket 220 is raised, the stamper 210 may be raised. When the stamper 210 is raised, the upper surface of the stamper 210 may come into contact with the second electrode surface 22 (see FIG. 2) of the electrode sheet 20 (see FIGS. 1-4).

FIG. 16 is a block diagram of the electrode manufacturing device 10 according to an embodiment of the present disclosure. Referring to FIGS. 1-16, the electrode manufacturing device 10 may include an input unit 410.

The input unit 410 may obtain an input from a user, etc. The input unit 410 may generate a first signal S1. The first signal S1 may include information regarding the input obtained by the input unit 410.

The electrode manufacturing device 10 may include a sensor unit 420. The sensor unit 420 may include a camera that captures an image of the electrode sheet 20. For example, the sensor unit 420 may obtain an image of the electrode sheet 20. For example, after the oil stamping unit 200 applies oil to the electrode sheet 20, the sensor unit 420 may capture an image of the electrode sheet 20.

For example, the sensor unit 420 may include an X-ray generator and an X-ray detector. For example, the X-ray generator of the sensor unit 420 may emit X-rays onto the electrode sheet 20. For example, the X-ray detector of the sensor unit 420 may measure X-rays diffracted from the electrode sheet 20.

The sensor unit 420 may generate a second signal S2. The second signal S2 may include information measured by the sensor unit 420. For example, the second signal S2 may include information regarding an image of the electrode sheet 20. For example, the second signal S2 may include information regarding X-rays diffracted from the electrode sheet 20.

The electrode manufacturing device 10 may include a control unit 430. For example, the control unit 430 may perform an operation. For example, the control unit 430 may process a signal.

For example, the control unit 430 may be implemented through at least one of a processor, a central processing unit (CPU), a graphical processing unit (GPU), a computer, a server, an electric circuit, and a circuit board.

The control unit 430 may generate output signals S3, S4 and S5 based on input signals S1 and S2. The input signals S1 and S2 may include at least one of the first signal S1 and the second signal S2. The output signals S3, S4 and S5 may include at least one of a third signal S3, a fourth signal S4, and a fifth signal S5.

For example, the control unit 430 may receive the first signal S1 from the input unit 410. For example, the control unit 430 may obtain information regarding an operation command of the electrode manufacturing device 10 from the first signal S1.

For example, the control unit 430 may receive the second signal S2 from the sensor unit 420. For example, the control unit 430 may extract information regarding oil applied to the electrode sheet 20 from the second signal S2. The information regarding the oil applied to the electrode sheet 20 may include, for example, at least one of a thickness and a distribution of the oil applied to the electrode sheet 20.

The mover 230 may receive the third signal S3. The mover 230 may operate according to the third signal S3. For example, the mover 230 may move the bracket 220 according to the third signal S3. For example, the mover 230 may move the bracket 220 upward and downward according to the third signal S3.

For example, the bracket 220 of the first oil stamping unit 201 and the bracket 220 of the second oil stamping unit 202 may move toward each other or away from each other.

When the bracket 220 moves toward the electrode sheet 20, the stamper 210 may come into contact with the electrode sheet 20. When the stamper 210 comes into contact with the electrode sheet 20, the oil contained in the stamper 210 may be applied to the electrode sheet 20.

For example, when the electrode sheet 20 is transported while the stamper 210 is in contact with the electrode sheet 20, the oil contained in the stamper 210 may be easily applied to the electrode sheet 20.

The electrode cutter 100 may receive the fourth signal S4. The electrode cutter 100 may operate according to the fourth signal S4. For example, the electrode cutter 100 may cut the electrode sheet 20 according to the fourth signal S4.

The oil supply unit 300 may receive the fifth signal S5. The oil supply unit 300 may operate according to the fifth signal S5. For example, an oil spraying unit (not shown) of the oil supply unit 300 may spray oil onto the stamper 210 of the first oil stamping unit 201 according to the fifth signal S5.

For example, the oil supply tube 320 of the oil supply unit 300 may supply oil to the bracket 220 of the second oil stamping unit 202 according to the fifth signal S5.

For example, the oil supply tube 320 of the oil supply unit 300 may supply oil to the housing 330 coupled to the second oil stamping unit 202 according to the fifth signal S5.

The electrode manufacturing device 10 may suppress oil waste by applying oil to a portion of the electrode sheet 20 to be cut. In particular, by minimizing an area of oil applied to the electrode sheet 20, degradation of the quality of the electrode sheet 20 may be suppressed.

The electrode manufacturing device 10 according to an embodiment of the present disclosure may include the oil stamping unit 200 including the stamper 210 formed of a porous material; and the oil supply unit 300 configured to provide oil to the oil stamping unit 200.

The oil stamping unit 200 may include the bracket 220 to which the stamper 210 is coupled, and the mover 230 coupled to the bracket 220 and configured to move the bracket 220.

The bracket 220 includes the bracket top 221 that forms an opening, and the stamper 210 may be located below the bracket top 221.

The stamper 210 may be exposed through the opening of the bracket top 221, and the oil supply unit 300 may include the oil spraying unit (not shown) configured to spray oil toward the opening.

The bracket 220 may further include the bracket finger 224 connected to the bracket top 221, and the stamper 210 may be coupled and fixed to the bracket finger 224.

The bracket 220 may include the bracket wall 222 extending downward from an upper end to a lower end and forming a hollow portion; and the bracket bottom 223 connected to the lower end portion of the bracket wall 222 and forming an opening.

The stamper 210 may include the stamper body 211 accommodated in the hollow portion of the bracket wall 222; and the stamper hand 212 protruding downward from the stamper body 211 and passing through the opening formed in the bracket bottom 223.

The inner surface of the bracket wall 222 may face the stamper body 211 and have a frustum shape.

The cross-sectional area of the inner surface of the bracket wall 222 may increase toward the bracket bottom 223.

The stamper 210 may be accommodated in the hollow portion formed in the bracket 220 open upward. The oil supply unit 300 may include the oil supply tube 320 connected to the bracket 220 and configured to provide oil.

The stamper 210 may have a shape protruding upward from an upper end of the bracket 220.

The oil supply unit 300 may include the housing 330 to which the bracket 220 is detachably coupled and which forms a space open upward; and the oil supply tube 320 configured to supply oil to the housing 330.

The housing 330 may include the housing case 331 forming a bottom surface and an outer surface of the housing 330; and the housing neck 332 having a well-wall shape extending upward from the bottom surface of the housing 330.

The bracket 220 may include the bracket bottom 223 forming the bottom of the bracket 220; and the bracket cap 225 protruding upward from the bracket bottom 223 and coupled to the mover 230.

One surface of the bracket cap 225 may be convex and may face the stamper 210. The other surface of the bracket cap 225 may be concave and may be coupled to the mover 230.

When the bracket 220 is in a lowered state, the bracket cap 225 may accommodate the housing neck 332. When the bracket 220 is in a raised state, the bracket 220 may be located above the housing 330.

The electrode manufacturing device 10 is a device configured to manufacture the electrode sheet 20 having the first electrode surface 21 and the second electrode surface 22 and being transported forward, and may include: the oil stamping unit 200 including the stamper 210 formed of a porous material and configured to move toward or away from the electrode sheet 20; the oil supply unit 300 configured to provide oil to the oil stamping unit 200; and the electrode cutter 100 located in front of the oil stamping unit 200 and configured to cut the electrode sheet.

The oil stamping unit 200 may include the bracket 220 to which the stamper 210 is coupled; and the mover 230 coupled to the bracket 220 and configured to move the bracket 220 toward or away from the electrode sheet 20.

In the electrode manufacturing device 10, the oil stamping unit 200 may include the first oil stamping unit 201 in which the stamper 210 faces the first electrode surface 21; and the second oil stamping unit 202 in which the stamper 210 faces the second electrode surface 22.

The bracket 220 may include the bracket top 221 that forms an opening, the stamper 210 may be located below the bracket top 221 and may face the first electrode surface 21, and the oil supply unit 300 may include an oil spraying unit (not shown) configured to spray oil toward the opening.

The electrode manufacturing device 10 may further include the sensor unit 420 configured to measure oil applied to the electrode sheet 20; and the control unit 430 configured to control the oil supply unit 300 based on the signal S2 received from the sensor unit 420.

The contents described above are merely examples of applying the principles of the present disclosure, and other configurations may be further included without departing from the scope of the present disclosure.

What is claimed is:

1. An electrode manufacturing device comprising:
an oil stamping unit including a stamper formed of a porous material; and
an oil supply unit configured to supply oil to the oil stamping unit,
wherein the oil stamping unit comprises:
a bracket to which the stamper is coupled; and
a mover coupled to the bracket and configured to move the bracket.

2. The electrode manufacturing device according to claim 1, wherein the bracket comprises a bracket top that forms an opening,
wherein the stamper is located below the bracket top.

3. The electrode manufacturing device according to claim 2, wherein the stamper is exposed through the opening of the bracket top, and
the oil supply unit comprises an oil spraying unit configured to spray oil toward the opening.

4. The electrode manufacturing device according to claim 2, wherein the bracket further comprises a bracket finger connected to the bracket top, and
the stamper is coupled and fixed to the bracket finger.

5. The electrode manufacturing device according to claim 1, wherein the bracket comprises:
a bracket wall extending downward from an upper end to a lower end and forming a hollow portion; and
a bracket bottom connected to a lower end portion of the bracket wall and forming an opening.

6. The electrode manufacturing device according to claim 5, wherein the stamper comprises:
a stamper body accommodated in the hollow portion; and
a stamper hand protruding downward from the stamper body and passing through the opening formed in the bracket bottom.

7. The electrode manufacturing device according to claim 6, wherein an inner surface of the bracket wall faces the stamper body and has a frustum shape.

8. The electrode manufacturing device according to claim 7, wherein a cross-sectional area of the inner surface of the bracket wall increases toward the bracket bottom.

9. The electrode manufacturing device according to claim 1, wherein the stamper is accommodated in a hollow portion formed in the bracket and open upward, and
the oil supply unit comprises an oil supply tube connected to the bracket and configured to provide oil.

10. The electrode manufacturing device according to claim 9, wherein the stamper has a shape protruding upward from an upper end of the bracket.

11. The electrode manufacturing device according to claim 1, wherein the oil supply unit comprises:
a housing to which the bracket is detachably coupled and which forms a space open upward; and
an oil supply tube configured to supply oil to the housing.

12. The electrode manufacturing device according to claim 11, wherein the housing comprises:
a housing case forming a bottom surface and an outer surface of the housing; and
a housing neck having a well-wall shape extending upward from the bottom surface of the housing.

13. The electrode manufacturing device according to claim 12, wherein the bracket comprises:
a bracket bottom forming a bottom of the bracket; and
a bracket cap protruding upward from the bracket bottom and coupled to the mover.

14. The electrode manufacturing device according to claim 13, wherein one surface of the bracket cap is convex and faces the stamper, and
the other surface of the bracket cap is concave and coupled to the mover.

15. The electrode manufacturing device according to claim 13, wherein when the bracket is in a lowered state, the bracket cap accommodates the housing neck, and
when the bracket is in a raised state, the bracket is located above the housing.

16. An electrode manufacturing device configured to manufacture an electrode sheet having a first electrode surface and a second electrode surface and being transported forward, comprising:
an oil stamping unit including a stamper formed of a porous material and configured to move toward or away from the electrode sheet;
an oil supply unit configured to provide oil to the oil stamping unit; and
an electrode cutter located in front of the oil stamping unit and configured to cut the electrode sheet.

17. The electrode manufacturing device according to claim 16, wherein the oil stamping unit comprises:
a bracket to which the stamper is coupled; and
a mover coupled to the bracket and configured to move the bracket toward or away from the electrode sheet.

18. The electrode manufacturing device according to claim 17, wherein the oil stamping unit comprises:
a first oil stamping unit in which the stamper faces the first electrode surface; and
a second oil stamping unit in which the stamper faces the second electrode surface.

19. The electrode manufacturing device according to claim 17, wherein the bracket comprises a bracket top that forms an opening,
wherein the stamper is located below the bracket top and faces the first electrode surface, and
the oil supply unit comprises an oil spraying unit configured to spray oil toward the opening.

20. The electrode manufacturing device according to claim 16, further comprising a sensor unit configured to measure oil applied to the electrode sheet; and
a control unit configured to control the oil supply unit based on a signal received from the sensor unit.
